(19) United States
(12) Patent Application Publication
(10) Pub. No.: US 2023/0081819 A1
(43) Pub. Date: Mar. 16, 2023

(54) RECOMMENDATION PLATFORM FOR PHYSICAL RETAIL ENVIRONMENT

(71) Applicant: IMAGER HOLDINGS LIMITED, Auckland (NZ)

(72) Inventors: Mark Weir, Auckland (NZ); Daniel Johnson, Auckland (NZ); Thomas Lau, Auckland (NZ); Konstantinos Raptis, Auckiland (NZ)

(21) Appl. No.: 17/759,370

(22) PCT Filed: Jan. 21, 2021
(86) PCT No.: PCT/IB2021/050475

§ 371 Date: Jul. 24, 2022

(30) Foreign Application Priority Data
Jan. 24, 2020 (AU) 2020900191

(51) Int. Cl. G06Q 30/0282; G06Q 30/0601; G06T 7/70; G06V 20/52; G06V 10/75; G06V 10/94

(52) U.S. Cl. CPC G06Q 30/0282; G06Q 30/0639; G06Q 30/0625; G06T 7/70; G06V 20/52; G06V 10/751; G06V 10/94

(57) ABSTRACT

Systems and methods for providing insights to a consumer at a physical store are disclosed. The method includes: processing image data from the inside of a shopping cart to detect an event and determine an event type, the event type being an item addition event or an item removal event; determining a location of the shopping cart at the time of detecting the event; updating a temporary shopping session cache to include: the detected event, an item identifier of an item associated with the detected event, and location of the shopping cart at the time the event was detected; and responsive to detecting the event and the location of the shopping cart at the time of detecting the event: determine if insight is available based on the state of the temporary shopping session cache; and upon determining that the insight is available, generating and transmitting the insight to the consumer.

### TECHNICAL FIELD

Aspects of the present disclosure relate to recommendation platforms and in particular to methods and systems for providing real-time insights in a physical retail environment.

### BACKGROUND

There are many ways for tracking online user behaviour. For example, some systems may monitor user interactions on certain websites. Over the years, sophisticated systems and methods have been created that utilize this tracked user behaviour to enhance the user's online shopping experience (e.g., by providing targeted advertising and/or recommendations to users). For example, some online marketplaces track online user shopping behaviour and create user preference profiles based on, e.g., historical items the user has purchased or shown interest in. These user preference profiles can then be analysed to generate and forward targeted advertisements or recommendations to users. For example, if a user has recently purchased an LED television, the next time the user visits the online marketplace, the marketplace may recommend a sound bar (because historically that is what most people buy along with televisions). Alternatively, if a user has been reviewing headphones on the online marketplace, but hasn't purchased a pair as yet, the online marketplace may display recommended/discounted headphones the next time the user accesses the online marketplace. Such recommendations can improve a consumer's online shopping experience, assist them in making quicker purchase decisions, and thereby save the consumer valuable time that can be spent doing other activities.

Although this trend of tracking user behaviour and utilizing it to generate targeted recommendations has been successfully implemented by online marketplaces, it has not been adopted by physical stores with the same level of success. Accordingly, there exists a need for a systems or methods that can provide targeted recommendations to consumers when they are shopping in physical stores.

Background information described in this specification is background information known to the inventors. Reference to this information as background information is not an acknowledgment or suggestion that this background information is prior art or is common general knowledge to a person of ordinary skill in the art.

### SUMMARY

According to a first aspect of the present disclosure, there is provided computer implemented method for providing one or more insights to a consumer at a physical store, the method including: receiving image data of the inside of a shopping cart; processing the image data to detect an event and determine an event type, the event type being an item addition event involving the addition of an item to the shopping cart or an item removal event involving the removal of an item from the shopping cart; determining a location of the shopping cart at the time of detecting the event; updating a temporary shopping session cache to include the detected event, an item identifier of an item associated with the detected event, and location of the shopping cart at the time the event was detected; and responsive to detecting the event and the location of the shopping cart at the time of detecting the event: determine if an insight is available based on the state of the temporary shopping session cache; and upon determining that the insight is available, generating and transmitting the insight to the consumer.

According to a second aspect of the present disclosure, there is provided a recommendation platform for providing one or more insights to a consumer at a physical store, the recommendation platform including a recommendation server and a recommendation client in communication over a communication network, the recommendation client being operatively coupled to a shopping cart in the physical store, the recommendation server configured to: receive, from the recommendation client, image data of the inside of the shopping cart; process the image data to detect an event and determine an event type, the event type being an item addition event involving the addition of an item to the shopping cart or an item removal event involving the removal of an item from the shopping cart; determine a location of the shopping cart at the time of detecting the event; update a temporary shopping session cache to include the detected event, an item identifier of an item associated with the detected event, and location of the shopping cart at the time the event was detected; and responsive to detecting the event and the location of the shopping cart at the time of detecting the event: determine if an insight is available based on the state of the temporary shopping session cache; and upon determining that the insight is available, generate and transmit the insight to the consumer.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

In the drawings:

FIG. 1 illustrates an example recommendation platform implemented in a physical retail environment.

FIG. 2 is a block diagram of a recommendation client according to aspects of the present disclosure.

FIG. 3 is a block diagram of a recommendation server according to aspects of the present disclosure.

FIG. 4 is a block diagram of a consumer device according to aspects of the present disclosure.

FIG. 5 is a flowchart illustrating an example method for maintaining a temporary shopping session cache and providing a recommendation to a consumer based on a current shopping session according to some embodiments of the present disclosure.

FIG. 6 is a flowchart illustrating an example location-based recommendation sub-process.

FIG. 7 is a flowchart illustrating an example method for providing a recommendation to a consumer based on historical user behaviour.

While aspects of the present disclosure are amenable to various modifications and alternative forms, specific embodiments are shown by way of example in the drawings and are described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

### General Overview and Environment

Aspects of the present disclosure are directed to systems and methods for enhancing consumer experience in physical retail environments, for example stores, and in particular to providing personalized recommendations to consumers during a shopping session. To provide this functionality, aspects of the present disclosure utilize a recommendation platform that includes recommendation clients in communication with a recommendation server. Each recommendation client is associated with a shopping cart.

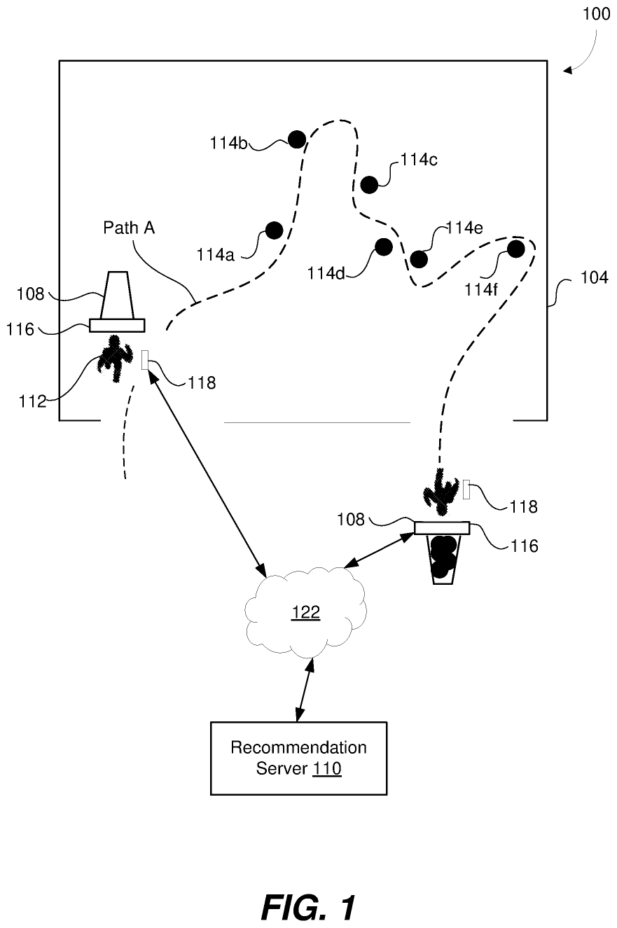

FIG. 1 illustrates an example environment 100 in which the various operations and techniques described herein can be performed. In particular, FIG. 1 illustrates an example environment 100 in which a recommendation platform according to some aspects of the present disclosure can be implemented. The environment 100 includes a physical store 104 selling items/products 114. The store 104 may be, for example, a supermarket, a hardware store, a warehouse, a clothing store, a shoe store, a furniture store, a cafeteria, or any other type of retail environment.

The store 104 supplies shopping carts 108 for consumers to place items in as they shop. The shopping cart 108 may be a trolley, hand-held basket or any other appropriate receptacle in which the consumer 112 can place products. Each cart 108 (or, at least, a selection of the carts 108 made available to consumers) is equipped with a recommendation client 116.

In addition to the recommendation client 116, the recommendation platform includes a recommendation server 110 that communicates with the recommendation clients 116 and/or consumer devices 118 (described further below).

A consumer 112 enters the store 104 and obtains a shopping cart 108 fitted with a recommendation client 116. The consumer has a consumer device 118, such as a mobile phone or other portable computing device. Once a consumer has selected a cart 108, the recommendation client 116 and server 110 communicate to establish a shopping session, linking the consumer device 118 to the recommendation client 116 of the selected cart 108. Thereafter, the consumer 112 proceeds through the store 104 selecting items 114 intended for purchase. For example, the consumer may traverse the store 104 along path A and add items 114a, 114b, 114c, 114d, 114e, and 114f to the shopping cart 108. Before exiting the store, the consumer 112 may decide against purchasing previously selected items and remove those items from their cart 108.

As the consumer progresses through the store adding and/or removing items from the cart 108, the recommendation client 116 captures image data (still and/or video) of the cart. The image data is communicated to the recommendation server 110 which processes it, identifies an event (i.e., an item added to the cart or an item removed from the cart) and identifies the item 114 that has been added to or removed from the cart 108. The recommendation server 110 also updates a temporary cache record of the items currently placed in the cart 108, and analyses this temporary cache record to determine whether one or more insights can be generated based on the items in the cart. As used herein, the term insight refers to a piece of information associated with a particular item 114 or the store 104. Insights may include further information about an item or the store, a notification about upcoming events/discounts at the store, a recommendation about an item, etc. If one or more insights can be generated, the recommendation server 110 sends the one or more insights to the recommendation client 116 and/or the consumer's device 118. For example, based on one or more items added to the shopping cart, the recommendation platform may recommend additional items and/or replacement items that the consumer may be interested in purchasing. This process is repeated each time an item 114 is placed in and/or removed from the cart 108. When the consumer 112 finishes shopping the shopping session ends.

In addition, the recommendation platform may determine a consumer's location within the store 104 and/or the path taken by the consumer 112 within the store. This location information can be used in addition to the shopping cart information to generate and deliver location-based insights. For example, if a consumer has added self-raising flour and caster sugar to his/her shopping cart, the recommendation platform may deliver a recommendation/reminder to the consumer to pick up cooking chocolate when the recommendation platform determines that the consumer is in the aisle where cooking chocolate is stocked.

If the consumer provides any personal information during the shopping session, the recommendation platform may maintain a persistent user profile for the consumer to record the items added, removed, and/or purchased by the consumer. This historic data can be utilized in conjunction with the real-time observed behaviour and/or location information to provide insights. For example, if the user profile indicates that a consumer periodically purchases milk, the recommendation platform may remind the consumer to pick up milk when they are near the section where milk is located.

The recommendation clients 116 and the recommendation server 110 communicate with each other over one or more wireless networks 122. Communications may be by any appropriate communications protocol, for example Wi-Fi. In order to handle the required data communications (and in particular data communications between the recommendation clients 116 and the recommendation server 110), a high speed/high capacity network is desirable. As one example, the store network 122 to which the recommendation clients 116 connect in order to communicate data (including image data) to the recommendation server 110 may be provided by units such as the Xirrus XR-600 or similar.

The consumer devices 118 and recommendation server 110 also communicate with each other via a wireless network. Consumer devices 118 may communicate with the recommendation server 110 using the same wireless store network 122 used to facilitate client 116/server 110 communications. Alternatively, consumer devices 118 may communicate with the recommendation server 110 over a separate network, for example an alternative Wi-Fi network, a cellular network (e.g. relying on 3G/4G or other cellular network technologies), or other communications network.

In the following sections, individual elements of the recommendation platform are described in detail.

### Recommendation Client

As described above, the recommendation client 116 may be configured to capture image data and communicate this data to the recommendation server 110. To that end, in its simplest form, the recommendation client 116 includes a camera configured to capture image data (still images and/or video) and a network interface configured to communicate the captured data to the recommendation server 110. The camera and network interface may be separate components or incorporated in a single device, such as a Wi-Fi camera. In one example, the Wi-Fi camera can be the Leopard Imaging wide dynamic range (WDR) serial camera LI-M38_OV2715.

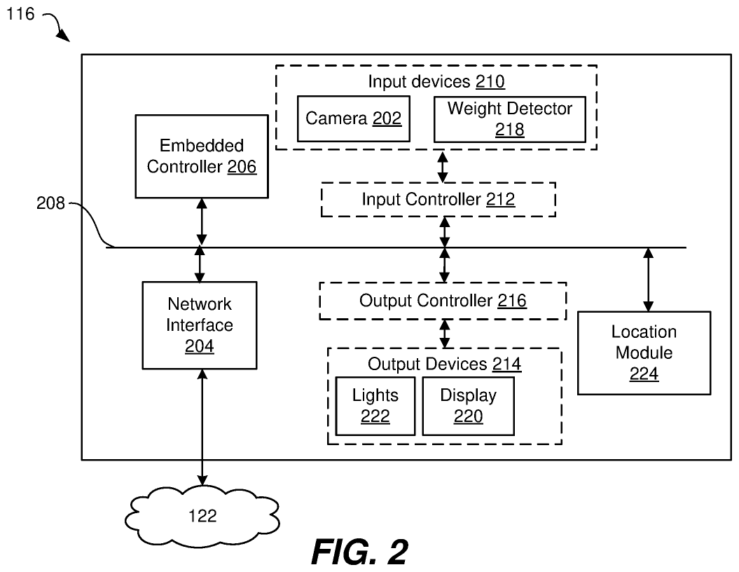

FIG. 2 illustrates one example of a recommendation client 116 in accordance with an embodiment. Recommendation client 116 can include an embedded controller 206, one or more input devices 210 (controlled by an input controller 212), one or more output devices 214 (in communication with an output controller 216), and a network interface 204. These components are interconnected through a system bus 208.

In certain embodiments, one of the input devices is a camera 202 (or group of cameras), which is/are mounted (or configured to be mounted) on or in the shopping cart 108 such that the portion of the shopping cart where items can be placed is within the viewing range of the camera(s). This can be achieved in various ways. For example, the recommendation client 116 may be configured so that the camera 202 is affixed to a pole or other support structure that elevates the camera 202 above the cart's interior, thereby providing a full, unobstructed view of the interior of the cart including the cart rim. In another configuration, the camera 202 may be affixed to the shopping cart in a manner such that the camera has a view straight ahead and can see items as they move past the camera (into the shopping cart). The support for the camera 202 may be positioned on the cart 108 so that multiple shopping carts can be nested within one another for storage without damaging the recommendation client 116 (e.g., by mounting the camera 202/recommendation client 116 to a handle of the cart 108).

Alternatively, the camera 202 may be detachably attached to a rim of the shopping cart 108. In this case, the camera 202 or the entire recommendation client 116 is detached and stored separately when the shopping cart 108 is not in use and attached to the cart when required.

While the recommendation client 116 of the described embodiments makes use of a single camera 202, it will be appreciated that more than one camera may be employed to capture images of the shopping cart. For instance, in a two-tier shopping cart, one camera may be utilized for each tier. Alternatively, multiple cameras may be utilised to view different sections of a single compartment of a shopping cart as required, or provide different views of the cart opening.

As different items may have very similar appearances high quality image data is preferred to enable items to be correctly identified by the recommendation platform. Accordingly, the camera 202 preferably records high quality images and videos. In one embodiment, the camera generates high dimension images having at least 1080 pixels and a frame rate of 25 frames per second. The high pixel count allows items that fill a fraction of the viewing angle to be properly captured, whereas the high frame rate allows the camera to capture clear and sharp images of moving items, for instance, when consumers throw items into the cart 108. In certain embodiments, the camera 202 uses the H.264 format or MPEG-4 Part 10 Advanced Video Coding format to record, compress image data captured by the camera 202 for communication to the recommendation server 110. It will be appreciated that any other format that can reduce the overall bandwidth required to transmit videos to the recommendation server 110 may be utilized without departing from the scope of the present disclosure.

The recommendation client 116 may further include input devices such as sensors or detectors configured to monitor a property and provide this information to the on-board controller 206. For instance, in certain embodiments the recommendation client 116 includes a weight detector 218 to determine a total weight of the items in the cart (and, from this, the weight increase/decrease that occurs as individual items are added/removed from the cart). The total weight in the cart can be compared with the weight of each identified item to determine whether all items in the cart have been identified correctly. In one aspect, the weight detector 218 may be a weight sensor coupled to the bottom of the cart. Alternatively, the weight detector may be made up of one or more tension meters coupled to vertical wire elements of the cart to measure tension in the vertical wires from the weight of items added to the cart. From the detected tension, the total weight of items in the cart can be calculated.

In certain embodiments, the recommendation client 116 includes a display 220 to provide information to consumer/staff. For example, the display 220 may be used to display recommendations generated by the recommendation server 110. The display 220 may be any appropriate device, for example a standalone display, or a touchscreen display.

The recommendation client 116 may further include lights 222. These lights may be affixed to the rim of the shopping cart and when turned on, may direct polarised light inside the shopping cart. The polarised light can help capture higher quality images of the shopping cart and reduce any reflections. The lights 222 can be activated whenever a shopping session is in progress or when the camera is active.

The network interface 204 is used to transmit data to and receive data from the recommendation server 110. In certain embodiments, the data transmitted from the client to the server can include image data captured/generated by the camera 202 and/or weight data (where a weight sensor 218 is used). The data received from the server at the client can include signals to activate or deactivate the input devices (e.g., when a shopping session commences or is completed). In order to facilitate communications, the network interface 204 includes a network interface controller (NIC) that allows the recommendation client 116 to access the network 122 and process low-level network information. For example, the NIC may have a connector for accepting a cable, or an aerial for wireless transmission and reception, and the associated circuitry.

In certain embodiments, the recommendation client 116 may also include a location module 224 such as a GPS receiver. In some aspects, instead of or in addition to a GPS receiver, the location module 224 may include an ultra-wideband (UWB) positioning system. UWB positioning systems are known to be able to pinpoint location in real time to within 20 centimetres or less. In addition, in certain embodiments, the location module 224 may also include an inertial measurement unit IMU (not shown) such as an accelerometer or gyroscope, which can be used in combination with the network interface 204 to accurately and reliably enable the recommendation platform to identify in-store location of the shopping cart 108. An example indoor positioning system that utilizes Wi-Fi signals and an IMU is the AnyPlace® navigation service by the Data Management Systems Laboratory of University of Cyprus. In addition or alternatively, any other positioning system such as Bluetooth that can provide accurate positioning information (with an accuracy of a few centimetres) indoors may be utilized without departing from the scope of the present disclosure. In case UWB or Bluetooth positioning is employed, the physical location may include positioning technology (e.g., UWB transmitters or Bluetooth beacons) that communicate with the corresponding systems on the recommendation clients 116 to establish positioning information.

In FIG. 2, the recommendation client 116 is depicted as a single block diagram. In some embodiments, the entire recommendation client 116 may be contained in a single housing. Alternatively, recommendation client 116 may be distributed, having multiple housings coupled to each other through wires or wirelessly. For instance, the camera 202 and lights 222 may be individually mounted on the cart 108 at appropriate positions and the weight detector 218 may be mounted on the bottom of the cart. The rest of the hardware may be housed in a separate housing mounted to the rear of the cart, the bottom of the cart, etc.

### Recommendation Server

The recommendation server 110 performs various operations/For example, and as described further below, the recommendation server 110 operates to:
a) Manage shopping sessions with consumers.
b) Receive image and/or weight data from the recommendation client 116.
c) Process the image and/or weight data to detect item events (i.e. items being added to/removed from the cart 108).
d) Process the image and/or weight data to identify specific items associated item events.
e) Retrieve location information from the recommendation client and/or an internal database in respect of identified items.
f) Maintain a temporary shopping session cache for items currently in a cart 108.
g) Determine a current location of the cart 108.
h) Communicate insights to consumer devices.
i) Manage consumer profiles and historic data.

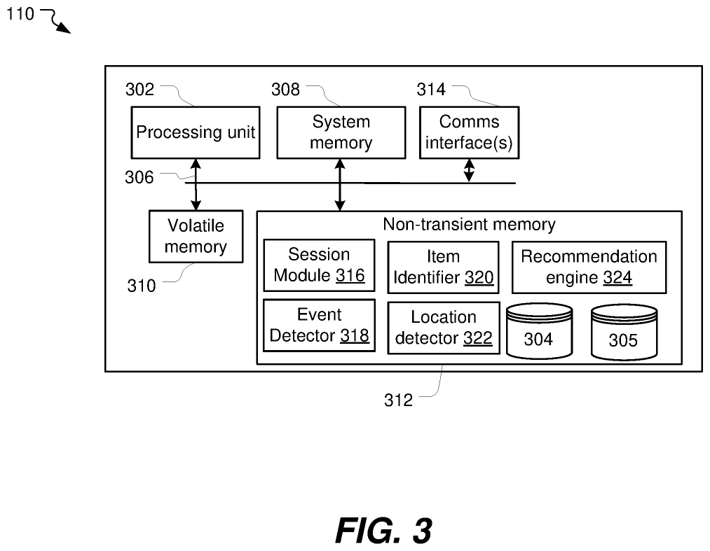

The recommendation server 110 is a computer processing system. FIG. 3 provides one example of a suitable computer processing system that can be used as the recommendation server 110.

As depicted in FIG. 3, recommendation server 110 includes a processing unit 302. Processing unit 302 may include one or more computational processing devices, potentially also including GPU (Graphical Processing Unit) subsystems (aka video cards.)

Through a communication bus 306, the processing unit 302 is in communication with computer readable system memory 308 (e.g. a read only memory storing a BIOS for basic system operations), computer readable volatile memory 310 (e.g. random access memory such as DRAM modules), and computer readable non-transient memory 312 (e.g., one or more hard disk drives). Instructions and data for controlling the processing unit 302 are stored in the memory 308, 310, and 312.

Non-transient memory 312 provides data storage for a database 304 for storing data associated with the programs. For instance, the database 304 may store product information such as stock images of items sold at the store 104, prices of items, locations of items, store inventory, store planogram or layout, and so on. In addition, non-transient memory 312 may provide data storage for database 305 for storing user profiles of consumers registered with the recommendation platform. In addition to consumer details, the user profiles may include, e.g., information about past shopping sessions (including items purchased and items removed from the shopping cart), and information about past insights delivered to the consumer and the success rate of such insights.

In addition, the non-transient memory 312 may include one or more temporary shopping session caches (not shown), each maintaining a record of an active shopping session and including a list of items added to and removed from all currently active shopping carts along with timestamps of the times at which the items were added/removed. Once a shopping session is concluded, if the consumer is registered with the recommendation platform, the shopping information maintained in the cache may be transferred to the consumer's user profile in the database 305.

Databases 304 and/or 305 may alternatively be stored on external computer readable storage accessible by the recommendation server 110 (via wired, wireless, direct or network connection).

The recommendation server 110 also includes one or more communication interfaces 314. Communications interfaces 314 are operated to provide wired or wireless connection to the communication network(s) 122. Via the communication interface(s) 314 and network(s) 122, recommendation server 110 can communicate with other computer systems and electronic devices connected to the network 122. Such systems include, for example, the recommendation clients 116, and the consumer devices 118. This communication enables the recommendation server 110 to send control messages, such as activate and deactivate signals to the recommendation client 116 and data such as insights to the consumer device 118. This communication also enables the recommendation server 110 to receive data, such as image data from the recommendation client 116 and user ID and recommendation client ID from the consumer device 118.

The recommendation server 110 is configured by executing software. Software, in the form of programs or modules, is stored in non-transient memory 312 and includes computer readable instructions and data. The instructions and data are read into system memory (e.g. 308) and executed by the processing unit 305 to cause the recommendation server 110 to provide the various functions and perform the various operations described herein.

One such module is a session module 316 that is configured to establish a shopping session by linking a particular consumer device 118 with a particular recommendation client 116, establish a temporary cache for the shopping session, transmit a signal for activating one or more input devices of the recommendation client 116, and establish a communication link between the recommendation server 110 and the recommendation client 116. Another such module is an item event detector module 318 that is configured to detect when an item is placed into or removed from a cart 108 based on image and/or weight data received from the recommendation client 116 (via the communication interface 314). The memory 312 also includes an item identifier module 320, which is configured to identify added/removed items based on the image and/or weight data associated with an event and record the identified items in the temporary shopping session cache.

In addition, the recommendation server 110 includes a location detector module 322 and a recommendation engine 324. The location detector 322 is configured to detect the location at which an event has occurred. This location detection can be performed in many different ways.

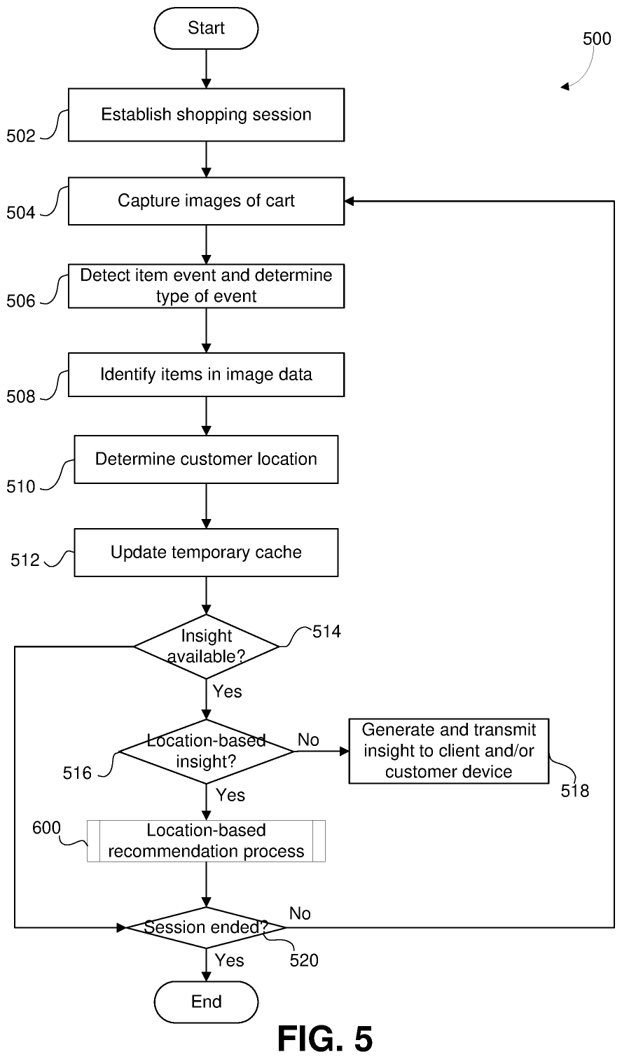

The recommendation engine 324 is configured to analyse session cache data for a particular session and generate real time insights based on items added to/removed from the cart. In certain embodiments, the recommendation engine 324 may also utilize the consumer's location (e.g., as determined by the location detector 322) and/or a consumer's historical purchase patterns (e.g., from the user profile) to generate insights for a particular consumer. These and other such programs/modules of the recommendation server 110 will be described in detail with reference to method FIGS. 5 to 7.

Alternative system architectures to that described above and illustrated in FIG. 3 are possible. Furthermore, in order to handle the required processing and communication load (and provide redundancy), the recommendation server 110 may include multiple computer systems (e.g. multiple computer servers) with, for example, a load balancer operating to direct traffic to/from a given computer system of the recommendation server 110. Alternatively, multiple computer systems may be utilized to perform separate functions of the recommendation server 110. Some of these systems might be located in the store 104, while others may be be off-location and in communication with the systems located in the store via the network 122.

### Consumer Device

Consumer devices 118 are, typically, personal computing devices owned by consumers. A consumer device 118 may, for example, be a mobile phone, a tablet, a watch, or any other portable electronic device capable of communicating with the recommendation server 110 and displaying information.

A consumer's device 118 is linked to a particular recommendation client 116 for the duration of a shopping session. During a shopping session, the consumer device 118 may receive insights from the recommendation server 110 based on items added to/removed from the cart 108 and display these insights to the consumer.

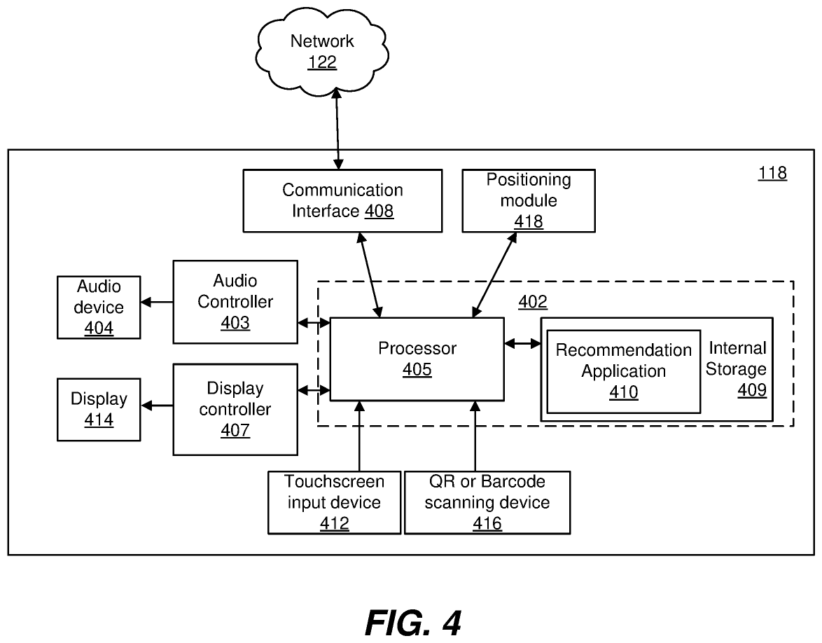

One example of a portable electronic device suitable for use as a consumer device 118 is shown in FIG. 4. In this example, consumer device 118 includes an embedded controller 402, having a processor 405 coupled to an internal storage module 409. A recommendation application 410 is installed and stored in the memory 409. When active, the recommendation application 410 includes instructions, which are executed to perform various functions. Example functions include:
a) Launching and running a recommendation application 410.
b) Capturing or otherwise enabling entry of a recommendation client identifier (i.e. an identifier that uniquely identifies a particular shopping cart 108/recommendation client 116).
c) Requesting a shopping session by transmitting recommendation client ID, user ID and (in certain embodiments) location data.
d) Displaying a user interface with cart information and recommendations for one or more items during an active shopping session.
e) Saving received and accepted insights in memory.

To help perform these functions, the consumer device 118 includes a display 414 (e.g. touch screen display, LCD display, LED display, or other display device). The display 414 is configured to display an interface for the recommendation application 410 in accordance with instructions received from the embedded controller 402, to which the display is connected. An audio device 404 (e.g. a speaker, headphones, or other audio device) may also be provided, the audio device 404 being configured to output sound in accordance with instructions received from the embedded controller 402.

The consumer device 118 also includes one or more user input devices. In some implementations, the user input devices may include a touch sensitive panel physically associated with the display 414 to collectively form a touch-screen 412. The consumer device 118 may also include an image capture device 416 (e.g. a camera) or other device capable of reading a QR code and/or barcode. Other user input devices may also be provided, such as a microphone (not illustrated) for voice commands or a joystick/thumb wheel (not illustrated) for easily navigating menus.

The consumer device 118 further includes a communication interface 408 that allows the consumer device 118 to wirelessly communicate with the recommendation server 110. Examples of wireless connection include, High Speed Packet Access (HSPA+), 4G, 5G, Long-Term Evolution (LTE), Mobile WiMAX, Wi-Fi (including protocols based on the IEEE 802.1 family standards), Infrared Data Association (IrDA), Bluetooth®, and the like.

In certain embodiments, the consumer device 118 may also include a positioning module 418, such as a GPS receiver and/or an UWB transmitter/receiver. In UWB, UWB transmitters transmit RF signals and receivers receive these signals and utilize the time difference of arrival of RF signals to determine their location with respect to the transmitter and/or vice versa.

Other examples of systems that may be utilized for positioning may include an inertial measurement unit IMU (not shown) such as an accelerometer or gyroscope, which can be used in combination with the communication interface 408 to accurately and reliably enable the recommendation system to identify in-store location of the consumer. An example indoor positioning system that utilizes Wi-Fi signals and an IMU is the AnyPlace® navigation service by the Data Management Systems Laboratory of University of Cyprus.

### System Operation Overview

The operation of the systems described above in order to generate and provide insights to a consumer shopping in a physical store will now be described. In particular, FIG. 5 is a flowchart illustrating an example method for updating a temporary shopping session cache during a shopping session and providing one or more insights to a consumer based on the temporary shopping session cache. In addition to the temporary shopping session cache, the one or more insights generated by method 500 may be based on the consumer's past shopping information (e.g., retrieved from the consumer's user profile) and one or more shopping patterns identified from shopping sessions associated with multiple consumers.

In certain embodiments, the consumer is registered with the recommendation application 410. Consumer registration may be achieved in a variety of ways. In certain embodiments, when a consumer 112 installs and first accesses the recommendation application 410 on the consumer device 118, the recommendation application prompts the consumer 112 to register with the recommendation platform. Typically, the consumer is requested to provide a user identifier, and personal details such as name, address, contact details, etc. A password may also be requested for security purposes. Once these details are provided, the consumer device 118 transmits them to the recommendation server 110 via a secure link, which creates a user profile for the consumer and stores the received information against that user profile in the database 305. Registration may further include an authentication process where, for example, a code is communicated to/received at the consumer device 118. If the consumer returns the code to the recommendation server 110, the consumer's details are authenticated.

Typically, registration need only be performed once (e.g., when the application 410 is initially installed and opened). Thereafter, the user consumer is not required to reregister or login to the application, unless the recommendation application 410 is deleted or a new consumer device 118 is used.

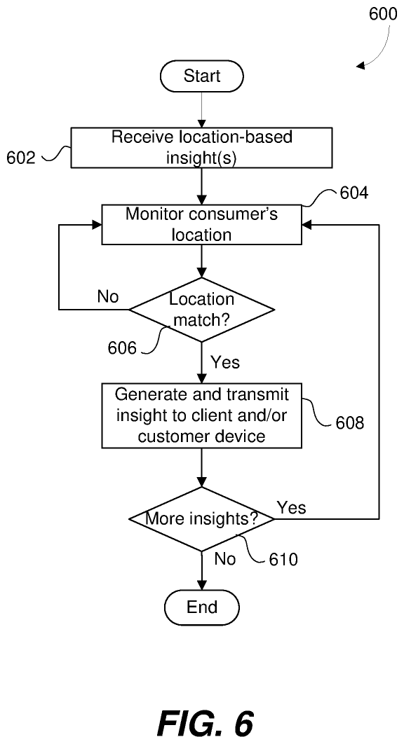

When the consumer enters the store 104, the method 500 begins at step 502, where a shopping session is established. This may be performed in a number of ways. For example, a consumer may select a shopping cart and providing a cart identifier of the selected shopping cart in the recommendation application 410. The recommendation application 410 then transmits the cart identifier and user ID to the recommendation server 110, which utilizes this information to link the recommendation engine 324 and the consumer's device 118, commence a shopping session (which includes establishing a temporary cache for the shopping session), and transmit signals to activate the input devices of the recommendation client 116. By way of example, one process for establishing a shopping session is described in detail with reference to FIG. 6 in PCT application PCT/NZ2017/050015 titled, “Systems and methods for shopping in a physical store”, which is incorporated herein by reference in its entirety.

After the shopping session is established, the consumer commences shopping. This involves the consumer adding items to and removing items from the cart. At 504 (during shopping), the recommendation client 116 captures image data of the inside of the shopping cart 108 (in case the camera is mounted to view the interior of the shopping cart) or of items as they move past the camera (in case the camera is mounted to capture image data straight ahead) and transmits the image data to the recommendation server 110. In certain embodiments, the camera 202 begins capturing image data when the shopping session commences and stops capturing image and video data when the shopping session ends. Where a weight detector 218 is used, the recommendation client 116 also communicates weight data to the recommendation server 110 whenever there is a change in the value of the weight data.

At 506, an item event is detected and the type of event is determined. An item event occurs when an item is added to or removed from a cart 108. An item event can be one of two types: an item addition event (where an item is added to a cart 108) and an item removal event (where an item is removed from a cart 108). In some embodiments, the recommendation client 116 detects an item event and determines the type of event. In other embodiments, this may be performed by the recommendation server 110. An example process for event detection and event type determination is described in detail in PCT application PCT/NZ2017/050015.

At 508, the recommendation server 110 analyses the image data with respect to an item event to identify one or more items associated with the event. The image data associated with a given event is typically the image data from immediately before the event (i.e. immediately before the item is added to or removed from the cart 108) to immediately after the event (i.e. immediately after the item has been added to or removed from the cart 108). An example item identification process is described in detail in PCT application PCT/NZ2017/050015.

At step 510, the recommendation server 110 determines (or estimates where definitive determination is not possible) the current location of the consumer. The present disclosure considers various ways to make this determination. For instance, in one example, if the recommendation client 116 includes a location module 224, the recommendation client 116 may transmit the current location determined by the location module 224 to the recommendation server 110. The location information may be transmitted continuously (when a shopping session is active), periodically (e.g., every few seconds or minutes), or upon detection of an event (e.g., an item addition or item removal event). Further, the recommendation client 116 may automatically transmit the location information to the recommendation server 110 based on the predefined frequency or the recommendation server 110 may request the recommendation client 116 to transmit this information when required.

Once the location information is received, the location detector module 322 may compare the received location information with a floor plan of the store 104 (stored in the database 304) to determine the consumer's location with respect to the aisles and/or store areas of the store 104.

In another embodiment, if the consumer device 118 includes a positioning module 418, the recommendation application 410 may be configured to retrieve location information from one or more of these units and transmit the location information to the recommendation server 110. As with the recommendation client 116 example, the frequency of transmitting the location information may be predefined and the recommendation application 410 may be configured to provide this location information automatically or when requested by the recommendation server 110.

In yet another embodiment, the location detector module 322 may determine the location of the consumer based on the item(s) identified at step 508. As described previously, the recommendation server 110 stores the location (e.g., the aisle and counter number, and/or store area) for all the items stocked by the store 104 in the database 304. In this embodiment, the location detector module 322 may be configured to retrieve this location information for the item(s) identified at step 508 from the database 304. As the consumer is likely to have selected an item from its designated location in the store, the location detector module 322 determines the location of the selected item to be the location of the consumer at the time of the detected event. When location is determined in this manner, the consumer's location can only be determined each time an event is detected and the recommendation server 110 may be unaware of the consumer's location at other times during the shopping session. This may aid in protecting consumer privacy.

In some cases, if a consumer removes an item 114 from the shopping cart 108, the consumer may not put the item back where the consumer originally picked up the item from, but may place the removed item wherever the consumer has decided that he/she no longer wishes to purchase the item. Accordingly, it may not be possible to accurately determine the position of a consumer based on item removal events. However, the recommendation server 110 may be configured to estimate the position of the consumer within the physical location at the time of a removal event based on the determined position of one or more items added to the cart before and after the item removal event and the time duration between such item addition events.

Sometimes a store may have special promotional events where one or more items that are typically stocked in a particular location in an aisle are also displayed at a more prominent location in the store (e.g., at the end of an aisle, near the entrance and/or exits). In such cases, the same product may be located in different locations in the store. To disambiguate between these item locations, the location detector module 322 may review the location information of one or more items added to the shopping cart before the item with the ambiguous location is added and/or one or more items added to the shopping cart after the item with the ambiguous location is added to the cart. If one of the possible locations of the ambiguous item falls between the locations of the previously and subsequently added items, the location detector module 322 may be configured to select that location as the location of the consumer when the ambiguous item is selected.

Similarly, in some cases, a consumer may add an item to the shopping cart that was previously discarded by another consumer at a random location in the store. In this case, the location of the item added to the shopping cart may not correspond to the actual location of the consumer. To disambiguate in such situations, the location detector module 322 may review the location information of other items added to the shopping cart to detect any anomalies in the location data. For example, if the location detector module 322 determines that of the last three items added to the cart, the first and third items were in the same aisle whereas the second item was located three aisles over, the location detector module 322 may determine that the location information for the second item is incorrect and may either remove this location information from the temporary session cache or update this location information (e.g., based on an estimate derived on the basis of other recorded location information around that event).

It will be appreciated that to improve the accuracy of the determined location, the location detector module 322 may be configured to combine two or more of the above-described techniques for determining the location of the consumer. For example, the location detector module 322 may receive location information from the recommendation client 116 and the consumer's device 118 and determine the absolute location of the consumer based on a combination of the location information received from both these devices.

In another example, the location detector 322 may receive location information from one or both of the recommendation client 116 and the consumer's device 118 at the time an event is detected and may compare this location information with the location of the item identified at step 508 to determine the consumer's location. If the location information received from the recommendation client 116 and/or the consumer's device 118 is significantly different from the location of the identified item, the location detector 322 may be configured to determine either that the consumer has not picked up the item from its designated location in the store 104 and/or that the accuracy of the location information provided by the recommendation client and/or consumer's device 118 is poor. The location of other items in the shopping cart may be reviewed along with the location information received from the client 116 and/or consumer device 118 to verify. If it is then determined that the client 116 and/or consumer device 118 locations are accurate, the location detector 322 may disregard the location of the item and use the location information from the client 116 and/or consumer device 118 for that particular event.

Once the location information is determined, the recommendation server 110 records the identified item and its identified location in the temporary shopping session cache at step 512.

Table A illustrates one example of a temporary shopping session cache that is generated after a consumer has added three items to the shopping cart, removed one item and then added another item to the cart.

TABLE A
example temporary shopping session cache

| | | Products | | |
|---|---|---|---|---|
| Event Time | Event Type | Selected | Quantity | Location (x, y) |
| 12:20 | Product Selected | John’s Jam | 1 | 20, 20 |
| 12:25 | Product Selected | White bread | 1 | 25, 20 |
| 12:27 | Product Selected | Big Cow | 1 | 26, 20 |
| | | Butter | | |
| 12:30 | Product Removed | John’s Jam | 1 | |
| 12:31 | Product Selected | Pete’s Jam | 1 | 28, 22 |

The example temporary shopping session cache depicted in Table A includes:
An event time which is a timestamp at which an event is detected.
Event type, which indicates the type of event that was detected (whether it was an item added to the shopping cart or an item removed from the shopping cart).
Product selected, which indicates the item that is identified at step 508.
Quantity of item identified at step 508.
Location of the consumer at the time of the detected event.

At step 514, the recommendation engine 324 retrieves the consumer's user profile and any shopping patterns identified from shopping sessions associated with multiple consumers and analyses the temporary shopping session cache (e.g., as shown in table A) and determines whether one or more insights can be generated.

In some cases, the recommendation engine 324 may analyse the latest item added to the cache to determine, e.g., whether one or more insights can be provided based on this latest item alone. For example, if the recommendation engine 324 determines that the latest item added to the cache was never previously selected by the consumer (based on the consumer's user profile data), the recommendation engine 324 may generate an insight that includes additional information about the identified items. To this end, the recommendation engine 324 may retrieve product information for the selected item from the database 304. In one example, the item information is retrieved by performing a lookup in the database 304. Information may include item price, special discounts on the item, ingredients, dietary information, a stock image of the item, the expected weight of the item, etc.

In addition to information about identified items, the recommendation engine 324 can generate product recommendations. These may include recommendations for alternative products and can be based on e.g., the price of items, any offers/discounts available, user reviews, etc. For example, in the example depicted in table A above, when the product “John's Jam” is added to the temporary cache, the recommendation engine 324 analyses this product and identifies a similar item that is cheaper or healthier than “John's Jam” and generates a recommendation for the alternate product (e.g., Jim's Jam). To do this, the recommendation engine 324 queries the product database 304 and compares the price of the identified item with the price of other similar products in the same category or compares the total energy in the identified item with the total energy in other similar products to recommend a better alternative product.

Alternatively, product recommendations may include recommendations for products that the consumer and/or most users often buy in conjunction with the selected item. For example, if the consumer typically adds Jam to their shopping cart when they purchase butter, the recommendation engine 324 may analyse the product “Big Cow Butter” when it is added to the temporary cache and generate a recommendation to buy Jam. To make this connection, the recommendation engine 324 may analyse the consumer's user profile and/or maintain a database of shopping sessions for multiple users and form correlations between items based on the items typically purchased together by consumers. Over time as more data is added in the user profile or the aggregated database, the recommendation engine 324 may form strong correlations between certain products and use these correlations to make recommendations.

In other cases (or in addition), the recommendation engine 324 may analyse multiple items in the temporary shopping session cache to determine whether one or more insights can be provided. In one instance, the recommendation engine 324 analyses the products added to the temporary cache to determine whether one or more additional items should be ideally purchased with the items already purchased. For example, if a consumer has selected tomatoes, bread, and bacon during his/her shopping session, the recommendation engine 324 may determine that there is a high probability that the consumer may additionally wish to purchase, e.g., lettuce and/or mayonnaise (e.g., based on the consumer's past purchase behaviour or based on the shopping patterns gleaned from multiple consumers). In this case, the recommendation engine 324 may only generate a recommendation once tomatoes, bread and bacon are added to the cart and not when only one of the items (such as bread) is added as the number of possible items the consumer may wish to purchase in conjunction with bread may be very high.

The recommendations/insights generated by the recommendation engine 324 may either be location-based (e.g., recommendations to purchase one or more items) or location-independent (e.g., further information about an item 114, updates about the store 104, etc.). Accordingly, at step 514, if it is determined that one or more insights can be generated, the method proceeds to step 516, where a determination is made whether the insight is location-based. If the insight is determined to be location independent, the method proceeds to step 518 where the recommendation is generated and transmitted to the recommendation application 410 and/or the recommendation client 116 for display to the consumer.

Alternatively, if at step 516 it is determined that the insight is location-based, the location-based insight is passed to a location-based recommendation process 600 (which will be described in detail below) and the method 500 proceeds to step 520, where the recommendation server 110 determines whether the shopping session has ended (e.g., because the consumer has initiated a payment session). If it is determined that the shopping session has not ended, processes 506 to 518 are repeated as the consumer continues to shop and each time the consumer adds/removes items from the cart 108.

Returning to step 514, if it is determined at this step that no insights are currently available, the method 500 proceeds directly to step 520. It will be appreciated that method 500 and specifically steps 504-514 are repeated until the shopping session ends. Once the shopping session has ended, some or all of the data in the temporary shopping session cache is transferred to the consumer's user profile. For example, the list of items added to the cart and removed from the cart may be added to the user profile along with a date/timestamp for the shopping session. The recommendation engine 324 can analyse this data to identify one or more shopping patterns or behaviours associated with the consumer.

### Location-Based Recommendation Process

FIG. 6 illustrates an example location-based recommendation process 600 for delivering location-based insights to a consumer when location criteria is met. Each time a location-based insight is generated at step 514, the insight is passed to the location-based recommendation process which maintains a list of location-based insights for a particular consumer and continuously monitors the consumer's location to determine whether the consumer's location matches any of the maintained location-based insights. Insights are therefore delivered to the consumer at the right time and location such that the insights are most useful for the consumer.

Process 600 begins at step 602 where a location-based insight is received from process 500 (and specifically from step 514). In some embodiments, process 600 may receive the insight text and a trigger condition for the insight (e.g., a location and/or location range). The location and/or location range format may differ based on the type of retail environment. For example, in stores that have an aisle and rack arrangement, the location or location range may be provided in terms of aisle and rack numbers). In stores that have different sections/stalls, or different levels, the location or location range may be provided in terms of sections and/or levels. It will be appreciated that these are examples and that the trigger condition for the insight can be programmed as desired. For example, the retail environment may develop a “walking distance” measure for walking from one position in the retail environment to another (e.g., navigating through aisles). This walking distance may then be used as a trigger condition.

Further, the selected location range may vary depending on the frequency at which a customer's location is determined. For example, if a consumer's location is determined every few seconds, a narrow location range may be utilized. Alternatively, if the consumer's location is determined only when the consumer adds items to the cart, the location range may be larger. Further still, the location range may be dynamically updated based on the frequency at which a consumer adds items to a shopping cart.

Table B illustrates an example list of insights maintained by the recommendation engine 324.

TABLE B
Example list of insight data

| | Insight | Trigger |
|---|---|---|
| Insight text | location | condition |
| Remember to buy Milk | 20, 20 | ±1 |
| Did you pick up olive oil? | 18, 4 | ±0, 2 |
| Thinking of making BLT sandwiches | 16, 10 | ±1 |
| this week? Are you running out of Bacon? | | |
| You last purchased coffee pods | 11, 23 | ±0, 2 |
| four weeks ago, are you running low? | | |

The example list of insight data depicted in Table B includes:
Insight text.
Insight location that indicates the location of the item mentioned in the recommendation. In this example, item locations are identified by aisle and rack numbers. For example 20, 20 indicates that the item is location in aisle 20 and rack 20.
Trigger condition, which indicates the location range for delivering the insight. In this example, a ±1 means that the insight can be delivered if the customer's location is determined to be in either one aisle higher or one aisle lower. ±0, 2 means that the insight can be delivered when the consumer's location is determined to be in the same aisle as the item location, but in a range of two racks away from the item location.

At step 604, the recommendation engine 324 monitors the consumer's location. The location may be monitored using one or more techniques described with respect to step 510 in FIG. 5.

Next, at step 606, the recommendation engine 324 determines whether the monitored consumer's location matches the trigger condition for any of the location-based insights maintained by the recommendation engine 324. If the consumer's monitored location does not meet the trigger condition of any of the insights maintained by the recommendation engine 324, the recommendation server 110 may back-off for a predetermined period of time and return to step 604.

Alternatively, if at step 606, the recommendation engine 324 determines that the consumer's monitored location matches the trigger condition for one or more the location-based insights, the method proceeds to step 608 where the recommendation server 110 transmits the one or more insights to the recommendation client 116 and/or the consumer's device for display to the consumer and removes the corresponding insight data from the list.

At step 610, the recommendation engine determines if any more insights are present in the list. If it is determined that there are more location-based insights to be delivered at this step, the method proceeds to step 604 where the consumer's location is monitored. In some embodiments, the recommendation engine 324 may wait a predetermined period of time before returning to step 604.

Alternatively, if it is determined that the list is empty at step 610, the method 600 ends.

It will be appreciated that location-based recommendation process 600 is executed as long as insights are present in the list and the shopping session is on-going. If all insights in the list have been delivered, the process 600 ends. Alternatively, if the shopping session ends, but there are still insights in the list waiting to be delivered, process 600 may end and the list of insights may be deleted. In other embodiments, the recommendation server 110 may identify the most opportune moment to deliver the insights before the shopping session ends, and deliver these insights. For instance, if the recommendation engine 324 determines that the shopping session is about to end (e.g., because the consumer is near an exit area and/or has commenced a payment session), the recommendation engine 324 may be configured to deliver the undelivered location-based insights to the consumer before the shopping session ends. In another example, location-based insights may be delivered immediately after the recommendation engine 324 determines that the location associated with an insight is not on the consumer's path during the shopping session. For instance, if a location-based insight is meant to be delivered in a particular location (e.g., in aisle 3) and based on the location information associated with the consumer it is determined that the consumer has skipped that aisle while walking through the store (e.g., because the consumer added an item to their cart in aisle 2 and the next item was added to the cart in aisle 4), the recommendation server 110 may generate and communicate the insight to the consumer device/recommendation client when the recommendation engine 324 determines that the aisle has been skipped (e.g., after an item is added to the cart in aisle 4).

In certain embodiments, when a consumer is about to leave the shopping area, the recommendation engine 324 may be configured to check if any other insights can be generated—for example, based on the items added and/or removed from the cart, the recommendation engine 324 may be configured to offer a discount. Alternatively, the recommendation engine 324 may be configured to offer a discount on particular items—for example, the recommendation engine 324 may generate an insight to add an additional item (that may or may not already be in the consumer's shopping cart) to receive a discount.

In this manner, the recommendation engine 324 can perform the main process of detecting items added to or removed from a shopping cart and generating insights and the sub-process of delivering location-based insights simultaneously.

FIGS. 5 and 6 are described such that location-based insights are delivered whenever the location condition is met. However, in some embodiments, additional conditions may be programmed. For example, before delivering a location-based insight, the recommendation engine 324 may be configured to determine whether the item(s) in the insight have already been added to the cart. To this end, the insight data may include the item identifiers of the items associated with the insights and the recommendation engine 324 may be configured to compare the item identifier of an insight with the item identifiers of the items in the temporary cache before delivering the corresponding location-based insight to the consumer. If the item identifier of the insight matches an item identifier of an item already added to the cart, the insight may simply be deleted without delivery. In another embodiment, if the item identifier of the insight matches an item identifier of an item already added to the cart, the recommendation engine 324 may be configured to update the insight—e.g., if the insight was to remind the consumer to buy a particular item, the recommendation engine 324 may be configured to update the insight into a promotion or a discount offer if the consumer buys additional quantities of the same item or buys another item sold by the same manufacturer. In this case, the updated insight may be generated and delivered to the consumer in place of the original insight.

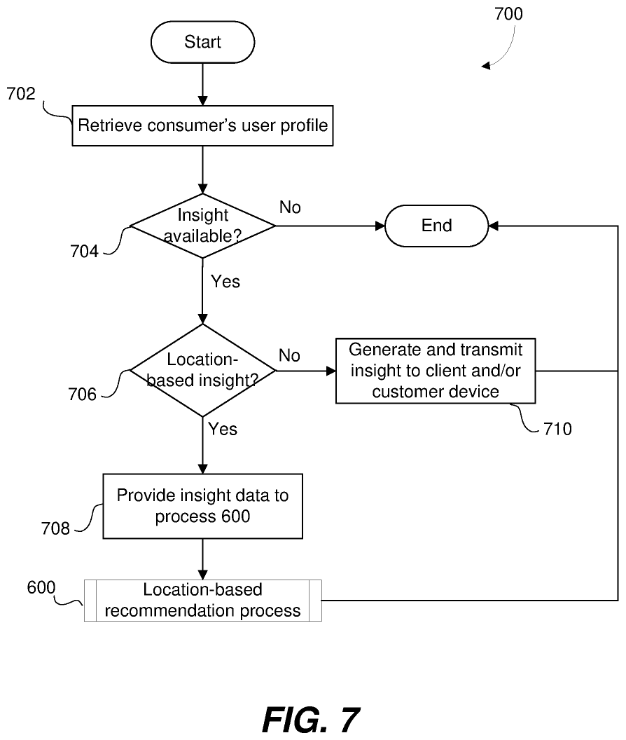

FIGS. 5 and 6 illustrated an example method for generating insights based on a current shopping session. As described previously, the recommendation engine 324 may also be configured to provide insights based on historical consumer behaviour. For example, if a consumer's user profile indicates that the consumer purchases 5 litres of milk every Sunday, the recommendation engine 324 may be configured to remind the consumer to pick up milk if the recommendation engine 324 determines that the consumer's current shopping session falls on a Sunday. FIG. 7 illustrates an example method 700 for providing recommendations based on historical data. Method 700 may commence when a shopping session is established.

At step 702, the recommendation engine 324 retrieves user profile data for the consumer associated with the current shopping session.

At step 704, the recommendation engine 324 determines whether one or more insights are available for the consumer. In some embodiments, the recommendation engine 324 may form an insight based on frequency of past purchases and/or identified shopping patterns.

In one example, the recommendation engine 324 may maintain a count of the number of times the consumer has purchased distinct items over a specific period of time. For example, the recommendation engine 324 may maintain a count of the number of times each item added to the shopping cart was purchased by a user in the past year. If the count for one or more items historically purchased by the consumer exceeds a threshold number (e.g., 30) the recommendation engine 324 may determine that the consumer is highly likely to purchase those items again. Alternatively, if an item was purchased only once, the recommendation engine 324 may determine that the consumer is not very likely to purchase that item again.

Further, the recommendation engine 324 may be configured to detect shopping patterns based on historical user shopping behaviour. For example, for a particular consumer, it may be determined that some shopping sessions are relatively short (less than 10 minutes) whereas other shopping sessions may be longer sessions (more than 30 minutes). Further, the consumer may purchase less than 10 items on any given weekday but may purchase more than 10 items on a weekend. From this, the recommendation engine 324 may determine that the consumer is likely to purchase only urgently needed items on weekdays and may not have time to review recommendations about alternative products on these days. Alternatively, the consumer may have more time to peruse the store 104 on weekends and may be more amenable to insights on these days.

In addition, if the physical store stocks perishable items, the recommendation engine 324 may maintain a database of typical expiry dates for the perishable items and/or approximate time an item lasts (based either on the historical purchase patterns of the consumer or multiple consumers). Based on this information and the past purchase data for the consumer, the recommendation engine 324 may determine which items previously purchased by the consumer may either be expired/close to expiry (e.g., based on last date of purchase and typical expiry periods) or may have run out of (e.g., based on the last date of purchase and the typical period such products last). It may then generate one or more product insights based on this analysis (e.g., ‘you may be running out of shower gel, want to pick up another one?’ or ‘the last mayonnaise jar you purchased in early 2018 is about to expire, want to restock?’).

The recommendation engine 324 may consider one or more of these factors at step 704 along with the current date and time to determine whether an insight can be generated.

If at step 704 it is determined that an insight can be generated, the method proceeds to step 706 where the recommendation engine 324 determines whether the insight is location-based or not. In some cases, the recommendation engine 324 may be configured to consider all item-based recommendations to be location-based whereas other types of insights may be handled as location independent insights. The determination made at step 706 is similar to the determination made at step 606 in FIG. 6 and therefore is not described in detail again.

If, at step 706, it is determined that the insight is location-based, the method proceeds to step 708 where the recommendation engine 324 provides the insight data from the location-based insight to the location-based recommendation sub-process 600 and the process 700 ends.

Alternatively, if at step 706 it is determined that the insight is location independent, the method proceeds to step 710, where the insight is generated and transmitted to the recommendation client 116 and/or consumer device 118 for display. After that method 700 ends.

Returning to step 704, if at this step it is determined that no recommendations are available, the method 700 ends.

It will be appreciated that in method 700 it is assumed that the recommendation engine generates one recommendation at step 704. However, in actual implementation, the recommendation engine may generate more than one recommendation at this step. In such cases, the recommendation engine 324 may determine each recommendation's type (e.g., whether it is location-based or not) and then transmit the location independent recommendations to the client 116 and/or consumer device 118. Insight data from all the location-based recommendations can be provided to location-based recommendation sub-process 600.

As described previously, insights may not only be generated based on a current shopping session and/or a consumer's historical shopping sessions, but they may also be generated based on shopping patterns identified from shopping sessions associated with multiple consumers. For example, if the sales of one or more items (e.g., umbrellas or a newly launched organic food range) significantly increases in a short period of time, (because multiple consumers have added one or more of these items to their shopping carts in a recent period), at the beginning of method 700, the recommendation engine 324 may determine whether the consumer associated with method 700 has recently purchased one or more of these “desired” items and if not, generate and deliver an insight to the consumer to consider purchasing one or more of these items.

Further, it will be appreciated that methods 500, 600 and 700 are described for one shopping session for a consumer. In actual implementation, there may be a number of consumers within the store at any given time and the recommendation platform may be configured to simultaneously manage shopping sessions and provide real time insights to all such consumers.

Further still, as described above, FIGS. 5 to 7 illustrate exemplary methods 500-700 as collections of steps in logical flowcharts. The flowcharts represent sequences of operations that can be implemented in hardware, software, or a combination thereof. When implemented in software, computer readable instructions are stored and executed by a computer processing device to cause the relevant system to perform the described operations. The software instructions may be formed as one or more code modules, each for performing one or more particular tasks. The order in which a given process is described in not necessarily intended to be construed as a limitation. In certain cases, the steps can be performed in a different order to that shown. Further, in certain cases multiple steps can be combined into a single step, a single step can be performed as multiple separate steps, additional steps can be included, and/or described steps can be omitted.

### Alternative Solutions

In addition to providing real-time insights to consumers, the recommendation platform may be utilized to deliver insights to the retailer. For example, the recommendation platform may be utilized to identify the likely locations of abandoned items. If an item is removed from a shopping cart, the recommendation platform may determine the locations of the items added to the shopping cart immediately before the item was removed and immediately after the item was removed. If timestamps are also provided for the time the two items were added and the item was removed, the recommendation platform can estimate a location range where the abandoned item can be found. A list of abandoned items can thus be generated periodically (e.g., once a day, once every few hours, or when a threshold number of items have been abandoned by customers) based on removed items from multiple shopping sessions. The list may include item identifiers of items that were removed, quantity of items, and likely location where the items were abandoned). Attendants can then utilize this list to retrieve the abandoned items and place them in their correct locations.

In addition to helping attendants find and replace these abandoned items, the information may be useful to assess, e.g., the most common places in the retail environment where consumer's remove unwanted items. Further still, this information may be useful in cases where the item is no longer available in its usual location (because the stock has run low). An attendants can quickly inform an enquiring customer of the likely location of the item (from the list of abandoned items).

Further, as the recommendation platform records the shopping sessions including time-stamps and consumer locations, it can accurately measure consumer dwell times and throughput, which can be used by retailers to optimize their store layout.

Further still, if consumer location is frequently received via the recommendation client and/or consumer device 118, the recommendation server 110 can identify when consumers have dwelled in an area for some time (e.g., because their location hasn't changed in a threshold period of time) and can be configured to alert attendants that the consumer may require specialized assistance. In this case, the consumer's location and cart identifier may be provided to the assistant.

The location and event information receiving from shopping sessions may also be used to dynamically update a planogram of the store (i.e., a map of products in the store). From time to time, physical stores update their store layout—e.g., they may change the location of cosmetics from one part of the store to another, change the location of their promotional items, etc. In such cases, instead of waiting for the retailer to send an updated store planogram each time changes are implemented, the recommendation engine 324 may be configured to dynamically update the store layout it maintains in database 304 based on the location of items added to consumer shopping carts. For example, in a threshold period of time, if a threshold number of consumers add a bakery item to their shopping cart from a location that was not previously associated with bakery items, the recommendation engine 324 may determine that the location of bakery items has changed and may automatically update its store layout. In some examples, the recommendation engine 324 may be configured to base this determination on additional factors as well such as a significant drop in the number of consumers adding a bakery item to their cart from the previously known location of bakery items.

### Alternative Embodiments

In the embodiments described above, the consumer device 118 is described as a mobile phone or tablet (or other portable device) owned by the consumer 112, with the recommendation application 410 installed and stored on the consumer device. Further, the consumer is registered with the recommendation application through the consumer's device and once registered, the consumer does not need to re-register or login each time they visit the store.

In an alternative embodiment, the functions of the consumer device 118 may be performed by the recommendation client 116. In this case, the recommendation application 410 is installed on the recommendation client 116 and the recommendation client 116 includes a user input device 210 (such as keyboard or keypad) and a display 220. When the consumer 112 selects a shopping cart 108, the display of the recommendation client 116 displays a login page, where the consumer can enter their login details such as a user name and password. If the consumer is shopping for the first time, the consumer first registers with the shopping support system.

Once the consumer is registered and authenticated, the shopping session may be established and the camera 202 may be activated. The other functions of the consumer device 118, such as displaying product and cart information can also be performed by the touchscreen display of the recommendation client 116.

One advantage of this embodiment is that the consumer 112 can shop without their consumer device. At the same time, however, the recommendation client 116 is likely to require more complex (and expensive) hardware, and as such become more expensive to replace if stolen/lost/damaged.

In yet another alternative embodiment, the recommendation application may operate to allow the consumer device to also perform the functionality of the recommendation client 116. In this case, the shopping cart 108 is fitted with a dock/mount to removeably secure the consumer's device to the cart 108 in a way that the camera of the consumer's device has a field of view covering the inside of the cart. If the consumer's device is mounted to the cart in such a manner that the entire interior of the cart is not in the viewing range of the camera, the recommendation application may generate an error message requesting the consumer to correctly dock the consumer device. Further, the communication interface of the consumer's device can be used to transmit images to the recommendation server 110, receive camera activation, and deactivation signals from the recommendation server.

An advantage of this embodiment is that the initial setup costs are reduced, as the store has to merely install a dock on the shopping cart 108. The replacement costs are also low. However, the shopping support system is limited by the quality of the camera in the consumer's device.

In the foregoing specification, embodiments of the present disclosure are described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

It will be understood that the invention disclosed and defined in this specification extends to all alternative combinations of two or more of the individual features mentioned or evident from the text or drawings. All of these different combinations constitute various alternative aspects of the invention.

1. A computer implemented method including:
receiving image data of the inside of a shopping cart;
processing the image data to detect an event and determine an event type, the event type being an item addition event involving the addition of an item to the shopping cart or an item removal event involving the removal of an item from the shopping cart;
determining a location of the shopping cart at a time of detecting the event;
updating a temporary shopping session cache to include the detected event, an item identifier of an item associated with the detected event, and location of the shopping cart at the time the event was detected; and
responsive to detecting the event and the location of the shopping cart:
determining if an insight is available based on a state of the temporary shopping session cache; and
upon determining that the insight is available, generating and transmitting the insight to the consumer.

2. The method of claim 1, further including:
determining whether the insight is a location-based insight, wherein the location-based insight is associated with a location in the physical store; and
upon determining that the insight is a location-based insight, adding the location-based insight to a list;
estimating a current location of the shopping cart;
determining whether the estimated current location of the shopping cart matches a location in the physical store associated with the location-based insight; and
delivering the location-based insight to the consumer upon determining that the estimated current location of the shopping cart matches the location associated with the location-based insight.

3. The method of claim 1, further including:
determining whether the insight is a location-based insight, wherein the location-based insight is associated with a location in the physical store; and
upon determining that the insight is a location-based insight, adding the location-based insight to a list;
estimating a current location of the shopping cart;
determining whether the estimated current location of the shopping cart matches a location in the physical store associated with the location-based insight;
identifying an item identifier of an item associated with the location-based insight; and upon determining that the estimated current location of the shopping cart matches the location in the physical store associated with the location-based insight, determining whether the item associated with the location-based insight is added to the shopping cart by performing a lookup of the item identifier associated with the location-based insight in the temporary shopping session cache; and
deleting the location-based insight from the list upon determining that the item associated with the location-based insight is already added to the shopping cart.

4. The method of claim 1, further including:
determining whether the insight is a location-based insight, wherein the location-based insight is associated with a location in the physical store; and
upon determining that the insight is a location-based insight, adding the location-based insight to a list;
estimating a current location of the shopping cart;
determining whether the estimated current location of the shopping cart matches a location in the physical store associated with the location-based insight;
identifying an item identifier of an item associated with the location-based insight; and
upon determining that the estimated current location of the shopping cart matches the location in the physical store associated with the location-based insight, determining whether the item associated with the location-based insight is added to the shopping cart by performing a lookup of the item identifier associated with the insight in the temporary shopping session cache;
updating the location-based insight upon determining that the item associated with the insight is added to the shopping cart; and
delivering the updated insight to the consumer.

5. The method of claim 1, wherein determining a location of the shopping cart includes receiving location information from a recommendation client operatively coupled to the shopping cart or from a consumer device at the time the event is detected.

6. The method of claim 1, wherein determining a location of the shopping cart includes:
maintaining a database including item identifiers of items available at the physical store and for each item identifier, the corresponding location of the item in the physical store;
comparing an item identifier of an item identified in an event involving the addition of an item to the shopping cart with item identifiers in the database to identify a match; and
assigning the location associated with the matched item identifier in the database to the location of the shopping cart at the time the event was detected.

7. The method of claim 2, wherein estimating a current location of the shopping cart includes:
retrieving a determined location of the shopping cart at one or more previous events from the temporary shopping session cache; and
estimating the current location of the shopping cart based on the determined location of the shopping cart at the one or more previous event and an elapsed time since the previous one or more events were detected.

8. The method of claim 1 wherein determining if the insight is available based on the state of the temporary shopping session cache includes determining if the insight is available based on the latest item added to the temporary shopping session cache.

9. The method of claim 1 wherein determining if the insight is available based on the state of the temporary shopping session cache includes determining if the insight is available based on multiple items added to the temporary shopping session cache.

10. The method of claim 1 further including:
retrieving a consumer profile associated with the consumer, the consumer profile including information about historical shopping sessions associated with the consumer;
identifying one or more shopping patterns based on the consumer profile;
determining whether one or more insights can be generated based on the identified one or more shopping patterns, and
generating and transmitting the determined one or more insights to the consumer during a current shopping session.

11. A recommendation system including a processor and a non-transitory computer-readable memory comprising instructions, which when executed by the processor cause the recommendation system to:
receive, from a recommendation client, image data of the inside of the shopping cart;
process the image data to detect an event and determine an event type, the event type being an item addition event involving the addition of an item to the shopping cart or an item removal event involving the removal of an item from the shopping cart;
determine a location of the shopping cart at a time of detecting the event;
update a temporary shopping session cache to include the detected event, an item identifier of an item associated with the detected event, and location of the shopping cart at the time the event was detected; and
responsive to detecting the event and the location of the shopping cart:
determine if an insight is available based on a state of the temporary shopping session cache; and
upon determining that the insight is available, generate and transmit the insight to the consumer.

12. The recommendation system of claim 11, wherein the non-transitory computer-readable memory further comprising instructions, which when executed by the processor cause the recommendation system to:
determine whether the insight is a location-based insight, wherein the location-based insight is associated with a location in the physical store; and
upon determining that the insight is a location-based insight, add the location-based insight to a list;
estimate a current location of the shopping cart;
determine whether the estimated current location of the shopping cart matches a location in the physical store associated with the location-based insight in the list; and
deliver the location-based insight to the consumer upon determining that the estimated current location of the shopping cart matches the location associated with the location-based insight.

13. The recommendation system of claim 11, wherein the non-transitory computer-readable memory further comprising instructions, which when executed by the processor cause the recommendation system to:
determine whether the insight is a location-based insight, wherein the location-based insight is associated with a location in the physical store; and
upon determining that the insight is a location-based insight, add the location-based insight to a list;
estimate a current location of the shopping cart;
determine whether the estimated current location of the shopping cart matches a location in the physical store associated with an insight in the list;
identify an item identifier of an item associated with the insight; and
upon determining that the estimated current location of the shopping cart matches the location in the physical store associated with the location-based insight, determine whether the item associated with the location-based insight is added to the shopping cart by performing a lookup of the item identifier associated with the location-based insight in the temporary shopping session cache; and
delete the location-based insight from the list upon determining that the item associated with the location-based insight is already added to the shopping cart.

14. The recommendation system of claim 11, wherein the non-transitory computer-readable memory further comprising instructions, which when executed by the processor cause the recommendation system to:
determine whether the insight is a location-based insight, wherein the location-based insight is associated with a location in the physical store; and
upon determining that the insight is a location-based insight, add the location-based insight to a list;
estimate a current location of the shopping cart;
determine whether the estimated current location of the shopping cart matches a location in the physical store associated with an insight in the list;
identify an item identifier of an item associated with the insight; and
upon determining that the estimated current location of the shopping cart matches the location in the physical store associated with the location-based insight in the list, determine whether the item associated with the location-based insight is added to the shopping cart by performing a lookup of the item identifier associated with the location-based insight in the temporary shopping session cache;
update the location-based insight upon determining that the item associated with the location-based insight is added to the shopping cart; and
deliver the updated location-based insight to the consumer.

15. The recommendation system of claim 11, wherein to determine the location of the shopping cart, the non-transitory computer-readable memory further comprising instructions, which when executed by the processor cause the recommendation system to receive location information from the recommendation client or from a consumer device at the time the event is detected.

16. The recommendation system of claim 11, wherein to determine the location of the shopping cart, the non-transitory computer-readable memory further comprising instructions, which when executed by the processor cause the recommendation system to:
maintain a database including item identifiers of all items available at the physical store and for each item identifier, the corresponding location of the item in the physical store;
compare an item identifier of an item identified in an event involving the addition of an item to the shopping cart with item identifiers in the database to identify a match; and
assign the location associated with the matched item identifier in the database to the location of the shopping cart at the time the event was detected.

17. The recommendation system of claim 12, wherein to estimate a current location of the shopping cart the non-transitory computer-readable memory further comprising instructions, which when executed by the processor cause the recommendation system to retrieve a determined location of the shopping cart at one or more previous events from the temporary shopping session cache and estimate the current location of the shopping cart based on the determined location of the shopping cart at the one or more previous events and an elapsed time since the previous one or more events were detected.

18. The recommendation system of claim 11 wherein the recommendation system determines if the insight is available based on the latest item added to the temporary shopping session cache.

19. The recommendation system of claim 11 wherein the recommendation system determines if the insight is available based on multiple items added to the temporary shopping session cache.

20. The recommendation system of claim 11 wherein the recommendation system is further configured to:
retrieve a consumer profile associated with the consumer, the consumer profile including information about historical shopping sessions associated with the consumer;
identify one or more shopping patterns based on the consumer profile;
determine whether one or more insights can be generated based on the identified one or more shopping patterns, and
generate and transmit the determined one or more insights to the consumer during a current shopping session.
